(19) United States
(12) Patent Application Publication
(10) Pub. No.: US 2025/0328397 A1
(43) Pub. Date: Oct. 23, 2025

(54) SPATIO-TEMPORAL GRAPH AND MESSAGE PASSING

(71) Applicant: Honda Motor Co., Ltd., Tokyo (JP)

(72) Inventors: Miles PRIEBE, Boston, MA (US); Nawid JAMALI, San Francisco, CA (US); Snehal Subhash DIKHALE, San Jose, CA (US); Soshi IBA, Mountain View, CA (US)

(21) Appl. No.: 18/910,962

(22) Filed: Oct. 9, 2024

Related U.S. Application Data
(60) Provisional application No. 63/635,725, filed on Apr. 18, 2024.

(51) Int. Cl. G06F 9/54; G06N 3/04

(52) U.S. Cl. CPC G06F 9/546; G06N 3/04

(57) ABSTRACT

According to one aspect, spatio-temporal graph message passing may include generating edges for a spatio-temporal graph. Nodes for the spatio-temporal graph may be defined by a first point cloud and a second point cloud. The edges may be generated based on a proximity between nodes of the spatio-temporal graph. The proximity may be defined based on a Euclidean distance or an embedding space distance. Message passing may be performed between respective nodes based on the proximity to generate updated feature vectors for respective nodes and a graph readout may be generated based on the updated feature vectors. Additionally, a downstream task may be performed based on the graph readout.

### CROSS-REFERENCE TO RELATED APPLICATIONS

This application claims the benefit of U.S. Provisional Patent Application, Ser. No. 63/635,725 (Attorney Docket No. H1241017US01) entitled “SPATIO-TEMPORAL GRAPH CONSTRUCTION AND MESSAGE PASSING SCHEME FORREPRESENTATION LEARNING”, filed on Apr. 18, 2024; the entirety of the above-noted application(s) is incorporated by reference herein.

### BACKGROUND

Spatio-temporal graphs or spatio-temporal graph neural networks are extension of graph neural networks (GNN) that account for time as a dimension. Spatio-temporal graphs have many relevant applications in computer vision and robotics. Examples include human activity recognition, human pose estimation, human trajectory prediction, and mobile robot navigation. A static spatio-temporal graph may have a number of nodes consistent across a time interval. A dynamic spatio-temporal graph may have a number of nodes, node features, and/or edge features which change over time.

### BRIEF DESCRIPTION

According to one aspect, a system for spatio-temporal graph message passing may include a memory and a processor. The memory may store one or more instructions. The processor may execute one or more of the instructions stored on the memory to perform one or more acts, actions, and/or steps. The processor may generate edges for a spatio-temporal graph. Nodes for the spatio-temporal graph may be defined by a first point cloud and a second point cloud. The edges may be generated based on a proximity between nodes of the spatio-temporal graph. The proximity may be defined based on a Euclidean distance or an embedding space distance. The processor may perform message passing between respective nodes based on the proximity to generate updated feature vectors for respective nodes and generate a graph readout based on the updated feature vectors. Additionally, the processor may perform a downstream task based on the graph readout.

According to one aspect, a computer-implemented method for spatio-temporal graph message passing may include generating edges for a spatio-temporal graph. Nodes for the spatio-temporal graph may be defined by a first point cloud and a second point cloud. The edges may be generated based on a proximity between nodes of the spatio-temporal graph. The proximity may be defined based on a Euclidean distance or an embedding space distance. The computer-implemented method for spatio-temporal graph message passing may include performing message passing between respective nodes based on the proximity to generate updated feature vectors for respective nodes and generating a graph readout based on the updated feature vectors. Additionally, the method for spatio-temporal graph message passing may include performing a downstream task based on the graph readout.

According to one aspect, a system for spatio-temporal graph message passing may include a memory and a processor. The memory may store one or more instructions. The processor may execute one or more of the instructions stored on the memory to perform one or more acts, actions, and/or steps. The processor may generate edges for a spatio-temporal graph. Nodes for the spatio-temporal graph may be defined by a first point cloud associated with a first sensor type and a second point cloud associated with a second sensor type. The edges may be generated based on a proximity between nodes of the spatio-temporal graph. The proximity may be defined based on a Euclidean distance or an embedding space distance. The processor may perform message passing between respective nodes based on the sensor type associated with respective nodes and the proximity to generate updated feature vectors for respective nodes and generate a graph readout based on the updated feature vectors.

### BRIEF DESCRIPTION OF THE DRAWINGS

FIG. 1 is an exemplary flow diagram of a computer-implemented method for spatio-temporal graph message passing, according to one aspect.

FIG. 2 is an exemplary component diagram of a system for spatio-temporal graph message passing, according to one aspect.

FIG. 3 is an exemplary illustration of a spatio-temporal graph message passing scheme associated with the computer-implemented method and system of spatio-temporal graph message passing of FIGS. 1-2, according to one aspect.

FIG. 4A is an exemplary illustration of intra-modality temporal message passing associated with the spatio-temporal graph of FIG. 3, according to one aspect.

FIG. 4B is an exemplary illustration of inter-modality temporal message passing associated with the spatio-temporal graph of FIG. 3, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

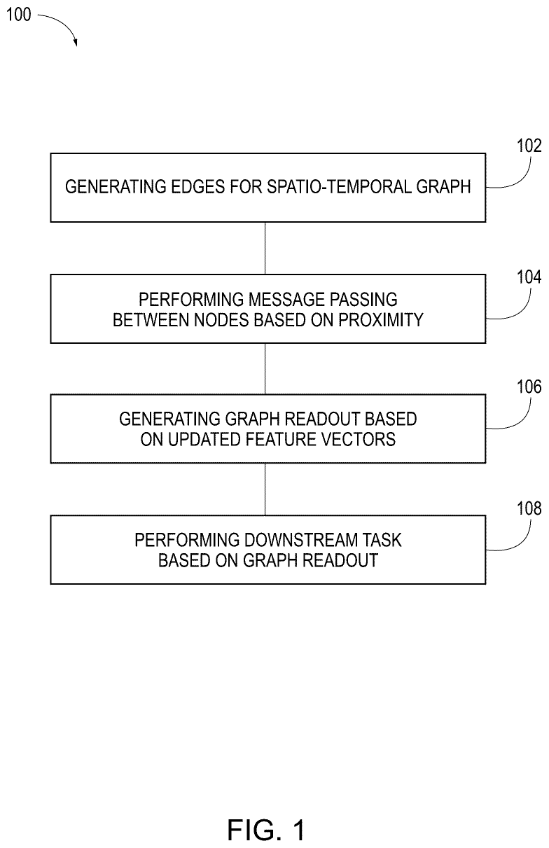

FIG. 1 is an exemplary flow diagram of a computer-implemented method 100 for spatio-temporal graph message passing, according to one aspect. The computer-implemented method 100 for spatio-temporal graph message passing may include generating 102 edges for a spatio-temporal graph. Nodes for the spatio-temporal graph may be defined by a first point cloud and a second point cloud. The edges may be generated based on a proximity between nodes of the spatio-temporal graph. The proximity may be defined based on a Euclidean distance or an embedding space distance. The computer-implemented method for spatio-temporal graph message passing may include performing 104 message passing between respective nodes based on the proximity to generate updated feature vectors for respective nodes and generating 106 a graph readout based on the updated feature vectors. Additionally, the method for spatio-temporal graph message passing may include performing 108 a downstream task based on the graph readout.

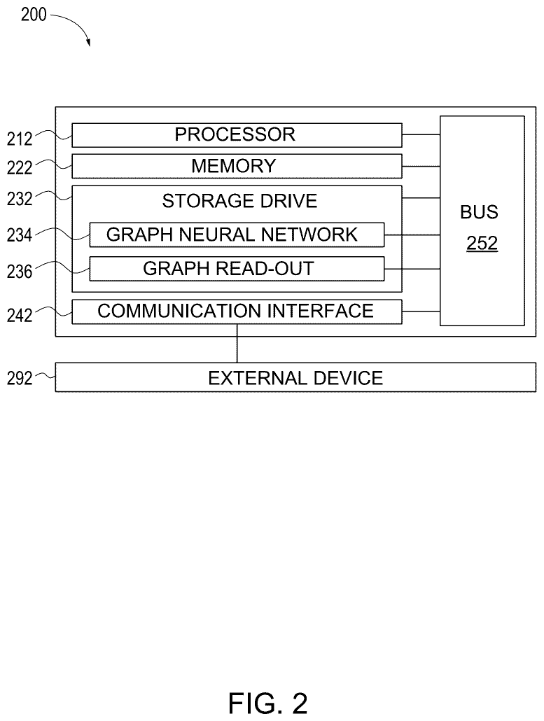

FIG. 2 is an exemplary component diagram of a system for spatio-temporal graph message passing, according to one aspect. The system for spatio-temporal graph message passing may include a processor 212, a memory 222, and a storage drive 232. The storage drive 232 may store a graph neural network 234 and a graph read-out 236. Additionally, the system for spatio-temporal graph message passing may include a communication interface 242 configured to receive information, such as the graph neural network and/or the graph read-out, such as from an external device 292. A bus 252 may communicatively couple respective components (e.g., the processor 212, the memory 222, the storage drive 232, the communication interface 242, etc.) and enable computer communication therebetween. The memory 222 may store one or more instructions. The processor 212 may execute one or more of the instructions stored on the memory 222 to perform one or more acts, actions, and/or steps.

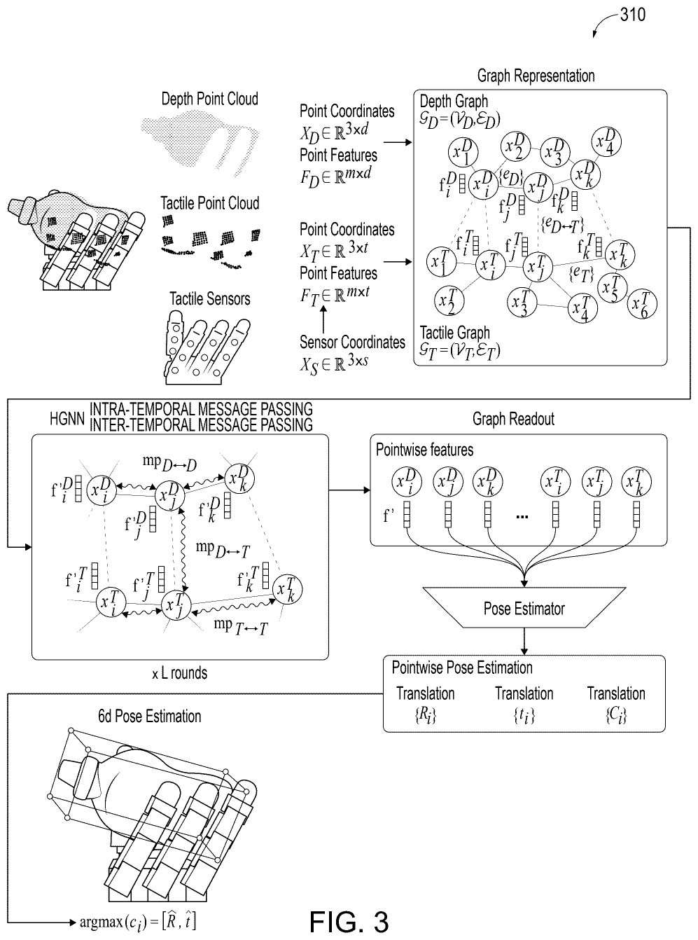

With reference to FIGS. 2-3, the processor 212 may generate a spatio-temporal graph based on data from two or more point clouds. The processor 212 may generate one or more edges for the spatio-temporal graph (e.g., graph representation of FIG. 3) and one or more nodes for the spatio-temporal graph based on the data from the point clouds. According to one aspect, nodes for the spatio-temporal graph may be defined by a first point cloud of the two or more point clouds associated with a first sensor type and a second point cloud of the two or more point clouds associated with a second sensor type. The edges of the spatio-temporal graph may be generated based on a proximity between nodes of the spatio-temporal graph. The spatio-temporal graph may be formulated as a hypergraph neural network (HGNN).

Although the disclose of spatio-temporal graph message passing is described herein with reference to exemplary pose estimation, it will be appreciated that the spatio-temporal graph message passing may be applied to any downstream task using any input data set (e.g., point clouds) for any corresponding problem.

For the exemplary problem of pose estimation or human pose estimation, reasoning regarding inconsistent or missing node locations across the temporal dimensions may be relatively straightforward; this may be due to the inherent constraints imposed by the dynamics of the human skeletal structure. By contrast, constraints between graph nodes of an object's position in a scene may be unconstrained and highly variable depending on a variety of physical properties of the object. This may greatly vary depending on the sensor modality used to extract such positional data. In this regard, obtaining tactile data to fuse with visual data may be challenging and constrained by various hardware limitations.

The system for spatio-temporal graph message passing provides the advantage or benefit of accounting for this high variability in node visibility and node location. The spatio-temporal graph construction method and message passing scheme may be designed to accommodate dynamic graphs using a temporal edge generation technique based on different types of proximity, where there are no constraints on the graph structure as the graph evolves over time, thereby enabling the learning of graph representations that effectively integrate information across the temporal dimension.

The framework provided in FIGS. 2-3 may enhance any graph network to effectively aggregate information across the temporal dimension. In particular, the framework may be beneficial for dynamically generated graphs that do not have consistent structure across the temporal dimension (e.g., HGNNs). Graph structures typically include nodes representing data points and edges that define the relationships between these points.

### Proximity—Euclidean Distance

According to one aspect, the proximity between two given nodes may be defined based on a Euclidean distance between the two given nodes. For example, physical 3-D distance may be utilized to connect the edges. In this example, the HGNN constructs grasp from point clouds using distance-based edges. Explained again, one approach to establishing a temporal edge may be to connect nodes that are “proximal” in 3-D space (x, y, z), across a heuristically determined time interval.

### Proximity—Embedding Space Distance

According to another aspect, the proximity between the two given nodes may be defined based on an embedding space distance. In dynamic systems, where data evolves over time, it may be useful to introduce temporal edges which may connect nodes which are proximal in terms of time. For example, the proximity may be defined as a Minkowski distance, discussed in greater detail herein. In other words, another approach to establishing temporal edges may be to connect nodes that are “proximal” in the embedding space. Here, “proximity” or “closeness” takes on a different conceptual meaning of similarity in the high-dimensional embedding space. In Equation (1), the formulation of distance in n-dimensional space, may be defined as the Minkowski distance:

$$d ( x , y ) = {( {\sum }_{i = 1}^{n} {\vert {x}_{i} - {y}_{i} \vert}^{p} )}^{\frac{1}{p}} \qquad ( 1 )$$

The processor 212 may utilize Equation (1) to determine a distance (e.g., a proximity) between points (x) and (y) in n-dimensional space. Additionally, p may represent the order of the norm. For example, when p=1, the order is the Manhattan distance. When p=2, the order is the Euclidian distance. When p>2, the order is a generalized distance in higher dimensions. In this way, the processor 212 may evaluate temporal proximity and generate edges based on the temporal proximity evaluation. For example, nodes which are closer than a sufficiently close proximity less than a threshold proximity may be connected in the spatio-temporal graph via an edge.

### Message Passing

The processor 212 may perform message passing between respective nodes based on the proximity between respective nodes to generate updated feature vectors for respective nodes. The message passing may be cross-modal and account for temporal aggregation. Additionally, the processor 212 may perform message passing based on multi-layer perceptron (MLP) functions. In this way, the message passing operations may include updates from node-specific and edge-specific MLP functions.

### Message Passing—Intra-Modality

The processor 212 may perform message passing between respective nodes based on the sensor type associated with respective nodes. For example, the processor 212 may perform message passing only between respective nodes having the same sensor type and between respective nodes having a sufficiently close proximity less than a threshold proximity. In this way, updated feature vectors may be generated via the intra-modality message passing.

### Message Passing—Inter-Modality

As another example, the processor 212 may perform message passing between respective nodes having a sufficiently close proximity less than the threshold proximity without regard to sensor type associated with the respective nodes. In this way, updated feature vectors may be generated via the inter-modality message passing.

### Graph Read-Out

The processor 212 may generate a graph readout based on the updated feature vectors. The graph readout summarizes or aggregates the information from the entire graph into a fixed-size vector. The aggregation may be done using various methods such as sum, mean, max, etc. The read-out is essentially a single vector that represents the entire graph, capturing/summarizing the relevant information for downstream tasks.

### Loss Function

Not only may the spatio-temporal graph message structure support custom temporal message passing schemes, but the spatio-temporal graph may also be encouraged to reason about temporal relationships through various objective functions. Along with any domain-specific objective function, an auxiliary loss function may be included to maintain temporal consistency and smoothness across model predictions. These loss functions include a derivative loss function and a Gram Matrix loss function, for example. The derivative loss may be beneficial for promoting temporal smoothness and fine-grained control over the temporal dynamics of model predictions. The Gram Matrix loss function may be advantageous for preserving feature correlations and ensuring global consistency in the generated output. In this way, the processor 212 may be configured to minimize a loss associated with the spatio-temporal graph neural network based on the derivative loss function or the Gram Matrix loss function.

The derivative loss may enforce temporal smoothness for joints located at limb terminals that commonly move faster during human motion, as shown in Equation (2):

$${L}_{d} = {\sum }_{t = 2}^{T} {\sum }_{i = 1}^{M} {\sum }_{s ∈ S} {η}_{S} {‖ {\hat{ϕ}}_{t , i}^{s} - {\hat{ϕ}}_{t - 1 , i}^{s} ‖}_{2}^{2} \qquad ( 2 )$$

In Equation (2),

$${\hat{ϕ}}_{t , i}^{s}$$

denotes the predicts 3-D locations of joints belonging to the set s, and η_{S} may be a scalar hyper-parameter that weights joints that are generally more stable, higher than others. L_{d} is the derivative loss, T is the total number of frames in the sequence, M is the number of joints (e.g., the number of sensed points on the object), S is the set of joint categories (e.g., different sensor modalities), and η_{S} is the hyper-parameter that assigns significance to different joint categories (e.g., different significance to different sensor modalities).

As discussed, derivative loss may be beneficial for promoting temporal smoothness and fine-grained control over the temporal dynamics of model predictions. Relating this to pose estimation, the system for spatio-temporal graph message passing may also control the temporal significance of specific points on either the object or the robot in order learn explicit relationships via the construction of the edges of the spatio-temporal graph and through the type of message passing utilized.

Another objective function that constrains the predictions to carry the temporal dependencies is the Gram matrix loss, which minimizes the distance between the covariances of predicted and ground-truth motions. The Gram matrix loss operates on feature correlations instead of the predictions themselves, as shown in Equation (3):

$${ℒ}_{gram} = \frac{1}{Δ T} {\sum }_{i = 1}^{M} {\sum }_{t = T = 1}^{T + Δ T} {‖ {V}_{i}^{( t - 1 , t )} - {\hat{V}}_{i}^{t - 1 , t} ‖}_{F}^{2} \qquad ( 3 )$$

In Equation (3), let the ground-truth position of the ith joint at time t, be

$${x}_{i}^{( t )} ∈ {R}^{3}$$

and the predicted position be

$${\hat{x}}_{i}^{( t )} ∈ {R}^{3} .$$

Define the Gram matrix of the ground-truth joint positions at two consecutive frames as

$${V}_{i}^{( t - 1 , t )} = {[ {x}_{i}^{( t - 1 )} {x}_{i}^{( t )} ] [ {x}_{i}^{( t - 1 )} {x}_{i}^{( t )} ]}^{T} ∈ {R}^{{D}_{x} \times {D}_{x}} ,$$

as well as the Gram matrix of the prediction joint positions as

$${\hat{V}}_{i}^{( t - 1 , t )} = {[ {\hat{x}}_{i}^{( t - 1 )} {\hat{x}}_{i}^{( t )} ] [ {\hat{x}}_{i}^{( t - 1 )} {\hat{x}}_{i}^{( t )} ]}^{T} .$$

Gram Matrix loss may be advantageous for preserving feature correlations and ensuring global consistency in generated output. Gram Matrix loss does not rely on the sequential nature of the data and may be used to enforce consistency in any high-dimensional feature space. The combination of the presented novel graph structure and temporal objective functions may be adapted to other spatio-temporal graph embodiments and various downstream tasks. [symbol] _{gram} gram may be the Gram Matrix loss, T may be the number of already observed time steps, ΔT may be the time interval over which a prediction is made, M may be the number of joints (e.g., the number of sensed points on an object), \hat{V} may be the predicted motion of a joint (e.g., a point on the object).

In this way, the computer-implemented method 100 and the system 200 of spatio-temporal graph message passing may provide enhancements for the structure and the scheme for graph-based methods for representation learning. The architecture of the system 200 of spatio-temporal graph message passing has the ability to capture spatial and temporal information of dynamic data distributions, while facilitating inter-modality and intra-modality information flow as well as spatial and temporal information flow.

### Downstream Task

The processor 212 may perform a downstream task based on the graph readout. Examples of downstream tasks include activity recognition, pose estimation or human pose estimation, trajectory prediction, and robot navigation of a robot including one or more robot systems, etc. According to one example, the external device 292 may be the robot and include one or more robot systems configured to perform any action (e.g., displaying, outputting, moving, etc.) based on the graph readout. Other examples may include using the graph readout as sensor data to control movements of a robot, for example, performing dexterous manipulation, and generating commands to navigate around obstacles, according to one aspect. Further, autonomous vehicles may use the readout to control the vehicle's steering, acceleration, and braking.

For example, the processor 212 may generate a pose estimation based on the graph readout. In this regard, FIG. 3 is an exemplary illustration of a spatio-temporal graph message passing scheme associated with the computer-implemented method and system of spatio-temporal graph message passing of FIGS. 1-2, according to one aspect. In FIG. 3, the first point cloud may include a depth point cloud (e.g., including visual data) and the second point cloud may include a tactile point cloud (e.g., including tactile data). The processor 212 may be configured as a pose estimator generating a pose estimation based on the graph readout. The pose estimation may be a 6D in-hand object pose estimation.

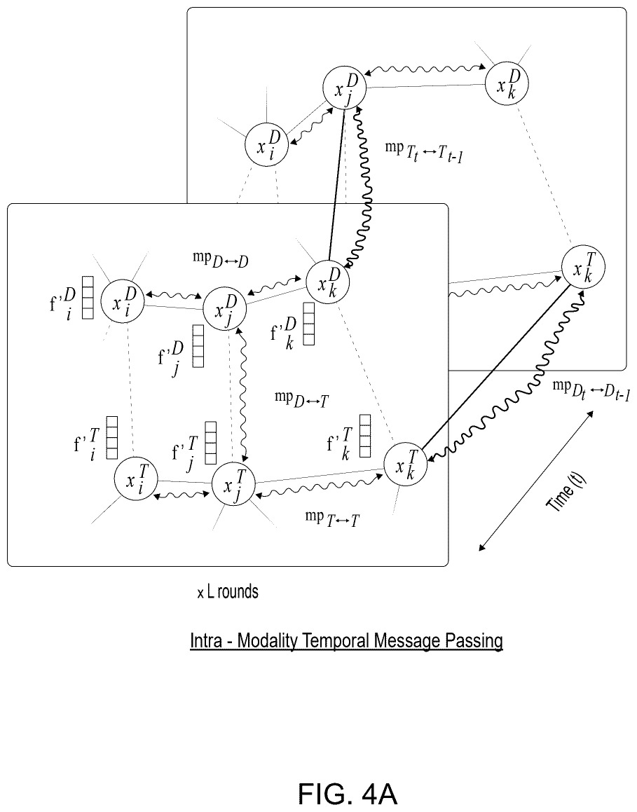

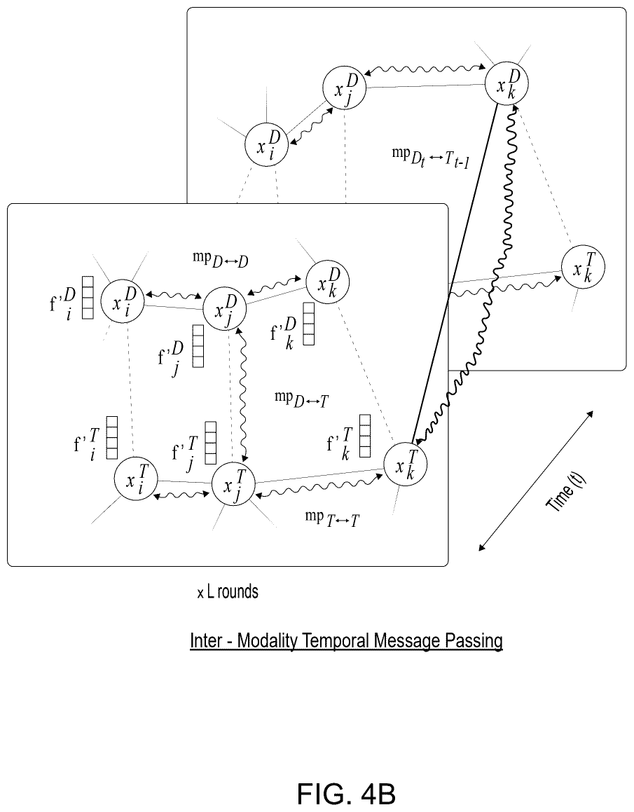

FIG. 3 illustrates an exemplary framework to combine multi-modal (e.g., vision and touch) data for a geometrically informed 6D object pose estimation. For example, FIG. 3 constructs two complementary graph structures 310 to represent the object surface geometry and the geometric arrangement of the tactile sensors on the robotic end-effector. The system also implements a hierarchical message passing scheme that allows for the flow of information between object and robot. This implicitly enables learning rich multi-modal tactile data representation that may be used in downstream robotic tasks. Further, this representation may fully exploit the temporal nature of these inter-dependencies and intra-dependencies, utilizing the spatio-temporal graphs from FIGS. 4A-4B rather than the graph representations of FIG. 3.

FIG. 4A is an exemplary illustration of intra-modality temporal message passing associated with the spatio-temporal graph of FIG. 3, according to one aspect. In this example, the processor 212 may perform message passing only between respective nodes having the same sensor type (e.g., sensor type T in FIG. 4A) and between respective nodes having a sufficiently close proximity less than a threshold proximity. In other words, the processor 212 may perform intra-modality message passing as mp_{D}_{ₜ}↔mp_{D}_{_{t−1}} for a depth graph associated with the image data point cloud and mp_{T}_{ₜ}↔mp_{T}_{_{t−1}} for a tactile graph associated with the tactile data point cloud.

FIG. 4B is an exemplary illustration of inter-modality temporal message passing associated with the spatio-temporal graph of FIG. 3, according to one aspect. In this example, the processor 212 may perform message passing between respective nodes having a sufficiently close proximity less than a threshold proximity, regardless of the corresponding sensor type (e.g., sensor type T to sensor type D in FIG. 4B). In other words, the processor 212 may perform inter-modality message passing as mp_{D}_{ₜ} ↔mp_{T}_{_{t−1}}, for example.

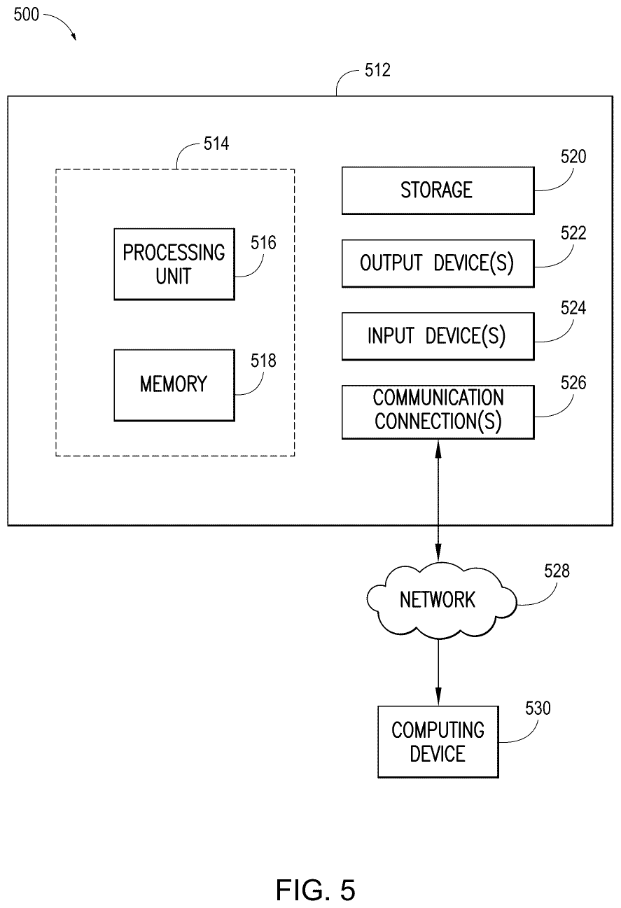

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

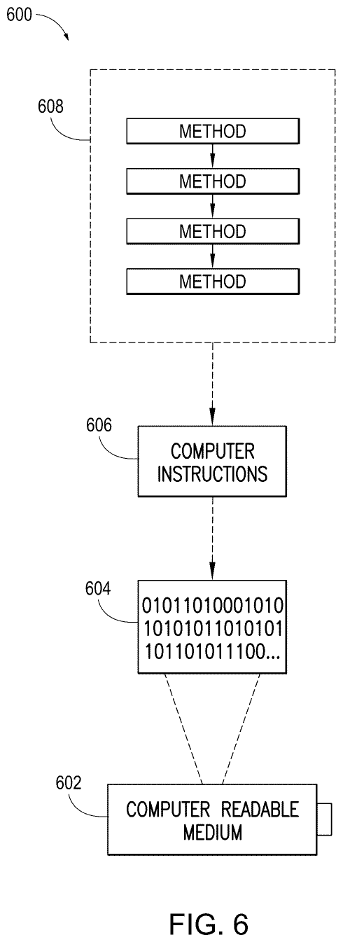

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 100 for spatio-temporal graph message passing of FIG. 1. In another aspect, the processor-executable computer instructions 606 may be configured to implement a system, such as the system 200 for spatio-temporal graph message passing of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

The invention claimed is:

1. A system for spatio-temporal graph message passing, comprising:
a memory storing one or more instructions;
a processor executing one or more of the instructions stored on the memory to perform:
generating edges for a spatio-temporal graph, wherein nodes for the spatio-temporal graph are defined by a first point cloud and a second point cloud, wherein the edges are generated based on a proximity between nodes of the spatio-temporal graph, wherein the proximity is defined based on a Euclidean distance or an embedding space distance;
performing message passing between respective nodes based on the proximity to generate updated feature vectors for respective nodes; and
generating a graph readout based on the updated feature vectors.

2. The system for spatio-temporal graph message passing of claim 1, wherein the processor performs a downstream task based on the graph readout.

3. The system for spatio-temporal graph message passing of claim 1, wherein the proximity is defined as a Minkowski distance.

4. The system for spatio-temporal graph message passing of claim 1, wherein the first point cloud is associated with a first sensor type and the second point cloud is associated with a second sensor type.

5. The system for spatio-temporal graph message passing of claim 4, wherein the processor performs message passing between respective nodes based on the sensor type associated with respective nodes.

6. The system for spatio-temporal graph message passing of claim 5, wherein the processor performs message passing only between respective nodes having the same sensor type.

7. The system for spatio-temporal graph message passing of claim 1, wherein the processor performs message passing based on multi-layer perceptron (MLP) functions.

8. The system for spatio-temporal graph message passing of claim 1, wherein the spatio-temporal graph is formulated as a hypergraph neural network (HGNN).

9. The system for spatio-temporal graph message passing of claim 1, comprising a pose estimator generating a pose estimation based on the graph readout, wherein the first point cloud and the second point cloud include a depth point cloud and a tactile point cloud.

10. The system for spatio-temporal graph message passing of claim 1, wherein the processor is configured to minimize a loss associated with the spatio-temporal graph neural network based on a derivative loss function or a Gram Matrix loss function.

11. A computer-implemented method for spatio-temporal graph message passing, comprising:
generating edges for a spatio-temporal graph, wherein nodes for the spatio-temporal graph are defined by a first point cloud and a second point cloud, wherein the edges are generated based on a proximity between nodes of the spatio-temporal graph, wherein the proximity is defined based on a Euclidean distance or an embedding space distance;
performing message passing between respective nodes based on the proximity to generate updated feature vectors for respective nodes; and
generating a graph readout based on the updated feature vectors.

12. The computer-implemented method for spatio-temporal graph message passing of claim 11, comprising performing a downstream task based on the graph readout.

13. The computer-implemented method for spatio-temporal graph message passing of claim 11, wherein the proximity is defined as a Minkowski distance.

14. The computer-implemented method for spatio-temporal graph message passing of claim 11, wherein the message passing is performed based on multi-layer perceptron (MLP) functions.

15. The computer-implemented method for spatio-temporal graph message passing of claim 11, wherein the spatio-temporal graph is formulated as a hypergraph neural network (HGNN).

16. A system for spatio-temporal graph message passing, comprising:
a memory storing one or more instructions;
a processor executing one or more of the instructions stored on the memory to perform:
generating edges for a spatio-temporal graph, wherein nodes for the spatio-temporal graph are defined by a first point cloud associated with a first sensor type and a second point cloud associated with a second sensor type, wherein the edges are generated based on a proximity between nodes of the spatio-temporal graph, wherein the proximity is defined based on a Euclidean distance or an embedding space distance;
performing message passing between respective nodes based on the sensor type associated with respective nodes and the proximity to generate updated feature vectors for respective nodes; and
generating a graph readout based on the updated feature vectors.

17. The system for spatio-temporal graph message passing of claim 16, wherein the processor performs a downstream task based on the graph readout.

18. The system for spatio-temporal graph message passing of claim 16, wherein the proximity is defined as a Minkowski distance.

19. The system for spatio-temporal graph message passing of claim 16, wherein the processor performs message passing only between respective nodes having the same sensor type.

20. The system for spatio-temporal graph message passing of claim 16, wherein the message passing is performed based on multi-layer perceptron (MLP) functions.
